(19) United States
(12) Patent Application Publication
(10) Pub. No.: US 2025/0312761 A1
(43) Pub. Date: Oct. 9, 2025

(54) OXYGEN CARRIER-MEDIATED HEATING SYSTEM

(71) Applicant: SINTEF TTO AS, Trondheim (NO)

(72) Inventors: Schalk CLOETE, Trondheim (NO); Jan Hendrik CLOETE, Trondheim (NO); Abdelghafour ZAABOUT, Trondheim (NO)

(73) Assignee: SINTEF TTO AS, Trondheim (NO)

(21) Appl. No.: 18/866,372

(22) PCT Filed: May 11, 2023
(86) PCT No.: PCT/EP2023/062629

§ 371 Date: Nov. 15, 2024

(30) Foreign Application Priority Data
May 16, 2022 (GB) 2207110.4

(51) Int. Cl. B01J 8/18

(52) U.S. Cl. CPC B01J 8/1836; B01J 2219/2427

(57) ABSTRACT

Disclosed herein is a reaction process system comprising: a reactor system configured to support an endothermic process of a feedstock: wherein the reactor system comprises: a reaction chamber with an internal region arranged to support the endothermic reaction of the feedstock; a heating system that is at least partially within the internal region of the reaction chamber; the heating system comprises a plurality of heating reactors; each heating reactor comprises walls that separate an internal region of the heating reactor from the rest of the internal region of the reaction chamber; each heating reactor comprises an oxygen carrier material in the internal region of the heating reactor; each heating reactor is arranged to support a reduction reaction between the oxygen carrier material and a fuel in the internal region of the heating reactor; and each heating reactor is arranged to support an oxidation reaction between the oxygen carrier material and oxygen in the internal region of the heating reactor; one or more heat exchangers arranged to generate the steam by heating water with heat recovered in dependence on one or more fluid flows out of the reactor system; and when applicable, a steam supply conduit arranged to supply at least some of the generated steam to the reactor system.

### FIELD

The present disclosure relates to a heating system with gas capture. The heating system according to an embodiment may be integrated into a reaction process that it provides heat for. The exhaust gas generated by the heating process in the heating system may comprise carbon dioxide. The exhaust gas may be captured so that it is not released directly into the atmosphere.

### BACKGROUND

There is a lot of environmental pressure to reduce the emissions of carbon dioxide gas into the atmosphere. A known technology for greatly reducing the carbon dioxide released into the atmosphere is carbon capture and storage, CCS. There are many ways in which CCS may be implemented.

Heating reactors provide the heat required for other processes. A main source of carbon dioxide is the burning of carbonaceous fuels in a heating reactor. A known technique is to capture the carbon dioxide in the exhaust gas of such a heating reactor.

There is a general need to improve the implementation of heating reactors and reactor systems for endothermic processes (e.g., calcination, reforming, gasification, pyrolysis).

### SUMMARY

Aspects of the invention are set out in the appended independent claims. Optional aspects are set out in the dependent claims.

### LIST OF FIGURES

FIG. 1 shows a reactor system according to an embodiment;

FIG. 2 shows a reactor system according to an embodiment;

FIG. 3 shows a biomass gasification and hydrogen production system according to an embodiment; and

FIG. 4 shows a steam power cycle system according to an embodiment.

### DESCRIPTION

Embodiments of the invention provide a heating system that comprises a plurality of heating reactors. Each heating reactor is arranged to generate heat by burning a carbonaceous fuel. The carbon dioxide that is generated by the combustion process in each heating reactor may be captured and not directly released into the environment. The heating system may be integrated with a reaction process that it provides heat for. A single reactor system may therefore comprise a chamber for supporting the reaction process and also the heating system. The fuel burnt in the heating system may also be at least partially derived from the products of the reaction process.

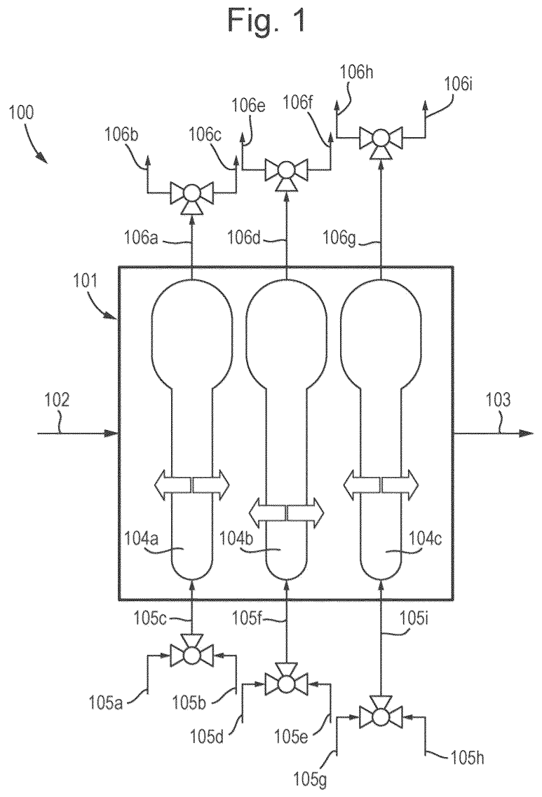

FIG. 1 shows a reactor system 100 according to an embodiment. The reactor system 100 comprises a reaction chamber 101 for supporting an endothermic reaction. The reaction chamber 101 has a feedstock inlet 102 for supplying reactants to the reaction chamber 101. The reaction chamber 101 has an outlet 103 for supporting a flow of reaction products out of the reaction chamber 101.

Heat for the reaction in the reaction chamber 101 is provided by a heating system. The heating system is provided within the reaction chamber 101. The heating system comprises a plurality of heating reactors 104a, 104b and 104c. Each heating reactor 104a, 104b and 104c may comprise an internal reaction region in which at least one exothermic reaction occurs for generating heat. The generated heat is conducted through the walls of the each heating reactor 104a, 104b and 104c to thereby deliver heat to the reactants inside the reaction chamber 101. The reaction of the reactants in each internal reaction region may be fluidised and this advantageously results in a high heat transfer rate. The internal reaction region of each heating reactor 104a, 104b and 104c is enclosed so that, within the reaction chamber 101, there is no mixing of the content of each internal reaction region and the content of the reaction chamber 101 outside of each heating reactor 104a, 104b and 104c.

A first heating reactor 104a has a gas inlet 105c for supplying gas, from outside of the reaction chamber 101, to the internal reaction region of the first heating reactor 104a. The supply of gas may be controlled by a valve system outside of the reaction chamber 101. The valve system may connect the gas inlet 105c to either an air supply 105b or a fuel supply 105a.

The first heating reactor 104a has a gas outlet 106a for supplying gas from the internal reaction region of the first heating reactor 104a to outside of the reaction chamber 101. The supply of gas may be controlled by a valve system outside of the reaction chamber 101. The valve system may connect the gas outlet 106a to either an oxygen depleted air supply 106c or a captured gas supply 106b.

A second heating reactor 104b has a gas inlet 105f for supplying gas, from outside of the reaction chamber 101, to the internal reaction region of the second heating reactor 104b.

The supply of gas may be controlled by a valve system outside of the reaction chamber 101. The valve system may connect the gas inlet 105f to either an air supply 105e or a fuel supply 105d.

The second heating reactor 104b has a gas outlet 106d for supplying gas from the internal reaction region of the second heating reactor 104b to outside of the reaction chamber 101.

The supply of gas may be controlled by a valve system outside of the reaction chamber 101. The valve system may connect the gas outlet 106d to either an oxygen depleted air supply 106f or a captured gas supply 106e.

A third heating reactor 104c has a gas inlet 105i for supplying gas, from outside of the reaction chamber 101, to the internal reaction region of the third heating reactor 104c. The supply of gas may be controlled by a valve system outside of the reaction chamber 101. The valve system may connect the gas inlet 105i to either an air supply 105h or a fuel supply 105g.

The third heating reactor 104c has a gas outlet 106g for supplying gas from the internal reaction region of the third heating reactor 104c to outside of the reaction chamber 101. The supply of gas may be controlled by a valve system outside of the reaction chamber 101. The valve system may connect the gas outlet 106g to either an oxygen depleted air supply 106i or a captured gas supply 106h.

The internal reaction region of each heating reactor 104a, 104b and 104c may comprise an oxygen carrier material. The internal reaction region may be a fluidised bed in which particles of the oxygen carrier material may react with a gas.

The operation of the first heating reactor 104a is described below.

An oxidation process of the oxygen carrier material may first be performed. The inlet valve system for first heating reactor 104a may be operated so that the gas inlet 105c supplies air, from the air supply 105b, to the internal reaction region of the first heating reactor 104a. Oxygen in the supplied air may react with the oxygen carrier material in the internal reaction region of the first heating reactor 104a. The reaction may occur in a fluidised bed. The reaction may be exothermic and generate heat. The reaction will consume at least some, and preferably substantially all, of the oxygen in the air supplied to the internal reaction region of the first heating reactor 104a. The outlet valve system for first heating reactor 104a may then be operated so that the oxygen depleted air in the internal reaction region flows through the gas outlet 106a and to the oxygen depleted air supply 106c.

A reduction process of the oxygen carrier material may then be performed. The inlet valve system for first heating reactor 104a may be operated so that the gas inlet 105c supplies fuel, from the fuel supply 105a, to the internal reaction region of the first heating reactor 104a.

The supplied fuel may then react with the oxygen carrier material in the internal reaction region of the first heating reactor 104a. The reaction may occur in a fluidised bed. The reaction may be exothermic and generate heat. The reaction may generate carbon dioxide and water. If incomplete reduction occurs, the reaction may also generate carbon monoxide. The reaction may reduce some, or all, of the oxygen carrier material so that it is returned to substantially the same state as before the above described oxidation process was performed. The outlet valve system for first heating reactor 104a may then be operated so that the carbon dioxide and water in the internal reaction region flows through the gas outlet 106a and to the captured gas supply 106b.

The above-described oxidation and reduction processes may then be cyclically repeated for the first heating reactor 104a.

The same above-described oxidation and reduction processes may also be cyclically performed for the second heating reactor 104b and third heating reactor 104c.

The first heating reactor 104a, second heating reactor 104b and third heating reactor 104c may be operated simultaneously but with a phase difference between the instantaneous operating state of each of the first heating reactor 104a, second heating reactor 104b and third heating reactor 104c. For example, when a reduction process is occurring in the first heating reactor 104a, an oxidation process may be approaching completion in the second heating reactor 104b and an oxidation process may be starting in the third heating reactor 104c. The plurality of heating reactors 104a, 104b and 104c may be operated so that, at any one time, there is at least one heating reactor in which a reduction process is occurring and there is at least one heating reactor in which an oxidation process is occurring.

The oxygen carrier material may be a copper or manganese based material, or any of a number of other types of oxygen carrier material. The oxygen carrier material may be one of the materials described in Zaabout, A., et al., A pressurized Gas Switching Combustion reactor: Autothermal operation with a CaMnO3-δ-based oxygen carrier. Chemical Engineering Research and Design, 2018. 137: p. 20-32, the entire contents of which are incorporated herein by reference.

The plurality of heating reactors 104a, 104b and 104c may be constructed and operated as described in Zaabout, A., et al., Experimental Demonstration of a Novel Gas Switching Combustion Reactor for Power Production with Integrated CO2 Capture. Industrial & Engineering Chemistry Research, 2013. 52(39): p. 14241-14250; and Zaabout, A., S. Cloete, and S. Amini, Autothermal operation of a pressurized Gas Switching Combustion with ilmenite ore. International Journal of Greenhouse Gas Control, 2017. 63: p. 175-183, the entire contents of both are incorporated herein by reference.

The plurality of heating reactors 104a, 104b and 104c therefore provide heat to the inside of the reaction chamber 101. The heat supplied by the plurality of heating reactors 104a, 104b and 104c allows the reaction chamber 101 to support an endothermic reaction of the reactants supplied through the feedstock inlet 102. The heating reactors 104a, 104b and 104c are therefore directly integrated into an endothermic industrial process. Examples of endothermic reactions that may occur within the reaction chamber include gasification, reforming, reverse water-gas shift, pyrolysis (of biomass/waste) and cracking, such as ammonia cracking.

Advantages of the reaction chamber 101 and heating system according to embodiments include:
The capture of exhaust gas, such as carbon dioxide, generated by the heating system.
The internal reaction region of each heating reactor 104a, 104b and 104c may be a fluidised bed. This provides a high heat transfer coefficient and minimizes the required heat transfer surface area.
The use of an oxygen carrier material allows fuel combustion with an equivalence ratio of 1. This avoids the efficiency penalties resulting from feeding excess air into a fuel combustion process.
The oxygen depleted air is an output stream of relatively pure nitrogen. This may be used in other applications, such as ammonia production.
The captured gas supply output from the heating system may be a mixture of substantially only carbon dioxide and water. The output stream may be used as the feedstock of a reformer for producing syngas. This may be used, for example, for methanol production or in other gas-to-liquid production processes.
The reaction products of the endothermic reaction performed in the reaction chamber 101 may comprise components that may be used as fuel in the heating system. The overall process integration is therefore highly efficient. For example, the by-products of processes such as gasification, reforming, methanol production, gas-to liquid production, and metallurgical processes may generate carbonaceous gasses such as methane and/or carbon monoxide. These carbonaceous gasses may be used as fuels by the heating system.

Some specific examples of processes that may use the reaction chamber 101 with an internal heating system according to embodiments are provided below.

The reactor system of embodiments may be used for, and integrated into, a biomass gasification process. The biomass gasification process may be used to produce hydrogen.

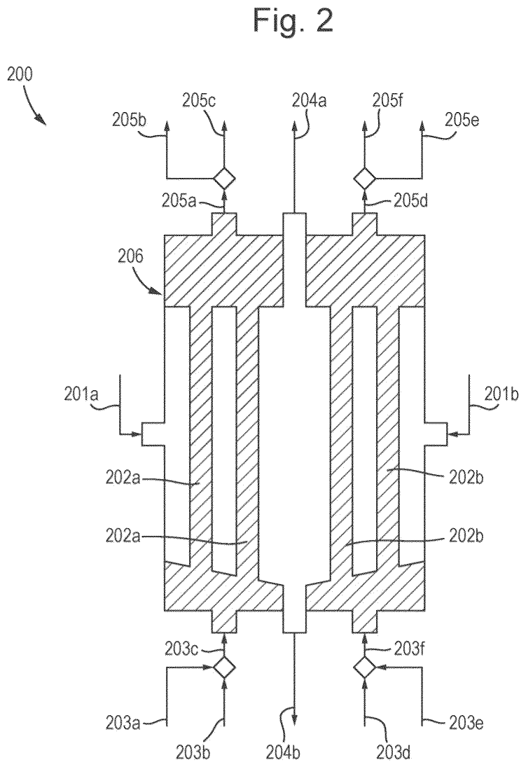

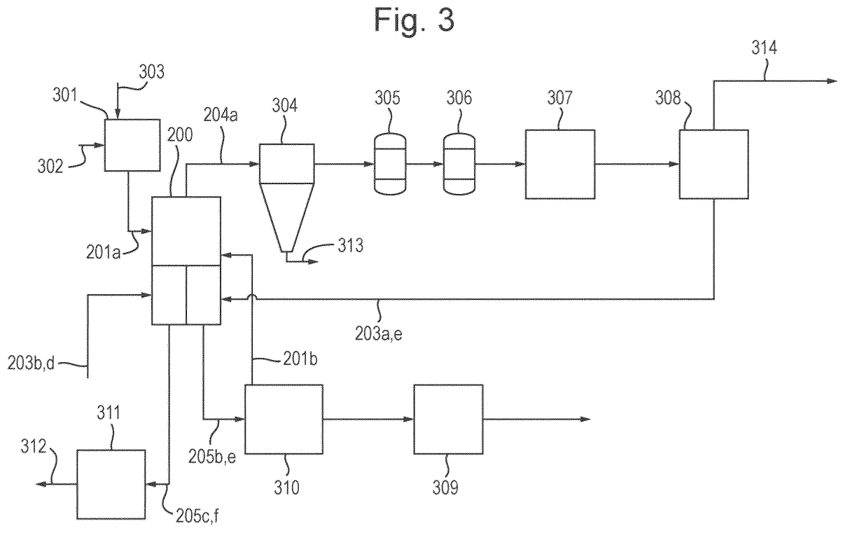

FIG. 2 shows a reactor system 200 according to an embodiment. The reactor system 200 is arranged to support a biomass gasification process. The reactor system 200 may be integrated into a biomass gasification and hydrogen production system, as described later with reference to FIG. 3.

The reactor system 200 comprises a reaction chamber 206 for supporting the endothermic reaction between biomass and steam. The reaction chamber 206 may be a single, continuous chamber that the tubes of a plurality of heating reactors 202a, 202b are arranged evenly within. The reaction chamber 206 has a first feedstock inlet 201a for supplying biomass to the reaction chamber 206. The reaction chamber 206 also has a second feedstock inlet 201b for supplying steam to the reaction chamber 206. The reaction chamber 206 has a first outlet 204a for supporting a flow of gaseous reaction products out of the reaction chamber 206. The reaction chamber 206 also has a second outlet 204b for supporting a flow of solid and/or liquid reaction products out of the reaction chamber 206.

Heat for the reaction in the reaction chamber 206 is provided by a heating system. The heating system is provided within the reaction chamber 206. The heating system comprises a plurality of heating reactors 202a and 202b. Each heating reactor 202a and 202b may comprise an internal reaction region in which at least one reaction occurs for generating heat. The generated heat is conducted through tubular walls of each heating reactor 202a and 202b to thereby deliver heat to the reactants inside the reaction chamber 206. The internal reaction region of each heating reactor 202a and 202b is enclosed so that, within the reaction chamber 206, there is no mixing of the content of each internal reaction region and the content of the reaction chamber 206 outside of each heating reactor 202a and 202b.

A first heating reactor 202a has a gas inlet 203c for supplying gas, from outside of the reaction chamber 206, to the internal reaction region of the first heating reactor 202a. The supply of gas may be controlled by a valve system outside of the reaction chamber 206.

The valve system may connect the gas inlet 203c to either an air supply 203b or a fuel supply 203a.

The first heating reactor 202a has a gas outlet 205a for supplying gas from the internal reaction region of the first heating reactor 202a to outside of the reaction chamber 206. The supply of gas may be controlled by a valve system outside of the reaction chamber 206. The valve system may connect the gas outlet 205a to either an oxygen depleted air supply 205c or a captured gas supply 205b.

The first heating reactor 202a may comprise a plurality of separate tubes. Each of the plurality of tubes may receive gas from the same gas inlet 203c, and output gas to the same gas outlet 205a. The chamber between the outlet end of each tube and the gas outlet 205a may be an expanding freeboard for preventing, or reducing, the flow of oxygen carrier material out of the reaction chamber 206. Each of the plurality of tubes may pass through the reaction chamber and the inside of each tube may provide part of the internal reaction region of the first heating reactor 202a.

A second heating reactor 202b has a gas inlet 203f for supplying gas, from outside of the reaction chamber 206, to the internal reaction region of the second heating reactor 202b. The supply of gas may be controlled by a valve system outside of the reaction chamber 206. The valve system may connect the gas inlet 203f to either an air supply 203d or a fuel supply 203e.

The second heating reactor 202b has a gas outlet 205d for supplying gas from the internal reaction region of the second heating reactor 202b to outside of the reaction chamber 206. The supply of gas may be controlled by a valve system outside of the reaction chamber 206. The valve system may connect the gas outlet 205d to either an oxygen depleted air supply 205f or a captured gas supply 205e.

The second heating reactor 202b may comprise a plurality of separate tubes. Each of the plurality of tubes may receive gas from the same gas inlet 203f, and output gas to the same gas outlet 205d. Each of the plurality of tubes may pass through the reaction chamber and the inside of each tube may provide part of the internal reaction region of the second heating reactor 202b.

FIG. 3 shows a biomass gasification and hydrogen production system according to an embodiment. The biomass gasification and hydrogen production system comprises the above-described reactor system 200.

The reactor system 200 is arranged to support the gasification of biomass. The gasification of biomass is a reaction between the biomass and steam. A particularly advantageous aspect of embodiments is that the steam required for the biomass gasification process may be efficiently generated due to the heat integration of processes. Although not shown in FIG. 3, a number of heat exchangers may be located in the biomass gasification and hydrogen production system. A heat exchanger may be provided whenever a cooling, or heating, of a fluid stream is required. In particular, heat exchangers may be provided on the input and output conduits of each component on the system so as to adjust the temperature of the fluid streams to more appropriate temperatures for the subsequent processes to be performed on the fluid streams. At least some of the steam that is supplied to the reactor system 200 may be generated by water that has been heated in one or more of the heat exchangers. The use of heat recovery by the heat exchangers improves the overall efficiency of the processes.

As shown in FIG. 3, the biomass gasification and hydrogen production system may comprise the reactor system 200, a lock hopper system 301, a gas-solid separator 304, a de-sulphurization reactor 305, a cracking reactor 306, a water gas shift reactor 307, a gas separation reactor 308, a steam power cycle system 310, a captured gas separator 309, and a turbine system 311.

The biomass gasification and hydrogen production system may be operated as described below.

The biomass may be supplied to the lock hopper system 301 through a feedstock supply conduit 302. The lock hopper system 301 may also receive pressurised carbon dioxide through a gas supply conduit 303. The carbon dioxide may pressurise the content of the lock hopper system 301. The content of the lock hopper system 301 may be pressurised to substantially the same pressure as that within the reaction chamber 206. The lock hopper system 301 allows the solid biomass to be fed into the reaction chamber 206 without substantial loss of the gasses within the reaction chamber 206. Some of the carbon dioxide supplied to the lock hopper system 301 may be lost to the environment with each loading of biomass into the reaction chamber 206 and some of the carbon dioxide may enter the reaction chamber with the biomass.

Biomass is supplied to the reaction chamber 206 through the first feedstock inlet 201a. Steam is supplied to the reaction chamber 206 through the second feedstock inlet 201b. Heat is generated within the reaction chamber 206 by the plurality of heating reactors 202a and 202b of the heating system.

The reaction chamber 206 may support a pressurised fluidised bed reaction between the biomass and the steam. The heat for the reaction is provided by the reaction chamber 206 and heating system operating as a shell-and-tube heat exchanger.

The gaseous reaction products of the biomass gasification process may flow out of the first outlet 204a of the reaction chamber 206. The solid reaction products of the biomass gasification process may flow out of the second outlet 204b of the reaction chamber 206. Although liquid reaction products of the biomass gasification process are not expected at the gasification temperature, any liquid reaction products that do arise may also flow out of the second outlet 204b of the reaction chamber 206. The gaseous reaction products of the biomass gasification process may comprise syngas. The syngas may comprise carbon dioxide, carbon monoxide, hydrogen, methane, other heavier hydrocarbons, and tar. Other gasses, such as steam, may also be present. A series of treatment and/or processing steps may be performed on the fluid flow of gaseous reaction products.

The fluid flow may be supplied to the gas-solid separator 304. The gas-solid separator 304 may be a cyclone separator. The gas-solid separator 304 may substantially remove any solid products, such as particles of ash and/or biomass, from the gaseous reaction products. The solid products may flow out of the system through conduit 313. The gaseous reaction products may flow from the gas-solid separator 304 to the de-sulphurization reactor 305.

The de-sulphurization reactor 305 may de-sulphurize the gaseous reaction products, i.e. remove any H₂S from the gaseous reaction products, by adsorption on ZnO, or other suitable sorbents. The de-sulphurization reactor 305 should operate at a temperature higher than the tar condensation point to ensure that tar components remain in a gaseous state. The de-sulphurization reactor 305 may operate at 400° C.

The gas flow out of the de-sulphurization reactor 305 may be supplied to the cracking reactor 306, that may be referred to as a tar cracker. The cracking reactor 306 may operate with a Ni catalyst. The received gas by the cracking reactor 306 may be reheated with the outlet gases in a recuperative heat exchanger and passed through a catalytic cracker to convert higher hydrocarbons and tars to light components.

The gas flow out of the cracking reactor 306 may be cooled in a recuperative heat exchanger and then supplied to the water gas shift reactor 307 followed by the gas separation reactor 308. Alternatively, instead of using the separate water gas shift reactor 307 and gas separation reactor 308, embodiments include using a membrane-assisted water gas shift reactor that may perform water gas shift and hydrogen separation in a single step.

The water gas shift reactor 307 may perform a two-step water-gas shift process on the received gas to transform most of the steam and carbon monoxide present to hydrogen and carbon dioxide. The gas flow out of the water gas shift reactor 307 may be cooled to ambient temperatures and a water removal process may be performed. The gas flow may then be supplied to the gas separation reactor 308. The gas separation reactor 308 may perform a pressure swing adsorption (PSA) that separates the hydrogen and the rest of the gaseous products (e.g., carbon dioxide, carbon monoxide, methane, unrecovered hydrogen, etc.).

Alternatively, instead of using the separate water gas shift reactor 307 and gas separation reactor 308, a membrane-assisted water gas shift reactor may be used that comprises hydrogen permeable membranes that continuously extract hydrogen produced during the water-gas shift reaction. The rest of the gaseous components (e.g., carbon dioxide, carbon monoxide, methane, unrecovered hydrogen, etc.) are unable to permeate the membranes and are thus separated from the hydrogen.

The hydrogen may flow out of the system through conduit 314. The hydrogen may be compressed to pipeline pressures for distribution or to elevated pressures required for a subsequent processing step, e.g., ammonia production.

The gas separation reactor 308, or membrane assisted water gas shift reactor, may also output an off-gas fuel that may comprise the rest of the gaseous products (e.g. carbon dioxide, carbon monoxide, methane, unrecovered hydrogen, etc.). The off-gas fuel may be output through a conduit that supplies the off-gas to the fuel supplies 203a and 203e of the heating system of the reactor system 200. If the PSA gas separator 308 is used, the off-gas fuel may be produced at near atmospheric pressure and compressed before it is supplied to the heating system of the reactor system 200. If the membrane-assisted water gas shift reactor 307-308 is used, the off-gas fuel is available at elevated pressure and the need for further compression is avoided.

The air supplies 203b,d of the reactor system 200 are supplied with a flow of air. The air supplied to the air supplies 203b,d may be compressed. The heating system of the reactor system 200 may operate as described above with oxidation and reduction processes cyclically performed by each of a plurality of heating reactors 202a and 202b in the heating system. Both the oxidation and reduction processes may be exothermic by selecting an appropriate oxygen carrier material. The heating system therefore provides the heat required for the reaction process between the biomass and steam in the reaction chamber 206.

There will be a period in the operating cycle of each heating reactor 202a,b in which oxygen depleted air is supplied to, and flows out of, an oxygen depleted air supply 205c,f. The oxygen depleted air may be a nitrogen rich stream. The oxygen depleted air may be cooled and fed to a downstream process that requires nitrogen such as ammonia production with the produced hydrogen. Alternatively, the oxygen depleted air may be supplied to a turbine system 311 for power generation. Power may be generated by the expansion of the oxygen depleted air in the turbine system 311. The oxygen depleted air may flow out of the turbine system in a conduit 312. The conduit may flow through a heat exchanger so that any excess heat in the oxygen depleted air may be recovered and used. In particular, the recovered heat may be used in the generation of the steam that is supplied to the second feedstock inlet 201b of the reactor system 200.

There will be a period in the operating cycle of each heating reactor 202a,b in which gas is supplied to, and flows out of, a captured gas supply 205b,e. The gas that is supplied to the captured gas supply 205b, e may be a gas mixture that comprises steam and the captured gas. The captured gas may be carbon dioxide. The captured gas may also comprise carbon monoxide. The gas mixture may be supplied to a steam power cycle system 310. The steam power cycle system 310 may be arranged to recover heat from the gas mixture and to generate a supply of steam to the second feedstock inlet 201b of the reactor system 200. The steam may be raised at a high pressure and partially expanded to the pressure of the reactor system 200 to increase efficiency. Any steam not required in reactor system 200 may be further expanded to vacuum pressures for additional power production. The steam power cycle system 310 may also condense any steam in the gas mixture that is supplied to a steam power cycle system 310 so that the gas flow out of the steam power cycle system 310 comprises substantially only the captured gas. After the steam in the gas mixture has been condensed, the flow of captured gas out of the steam power cycle system 310 may be over 90% pure. The flow of captured gas out of the steam power cycle system 310 may be supplied to a captured gas separator 309 where it may be further purified and/or compressed so that it is suitable for transportation and/or storage. Before compression, some of the capture gas may be supplied to the lock hopper system 301 for the earlier described pressurisation process.

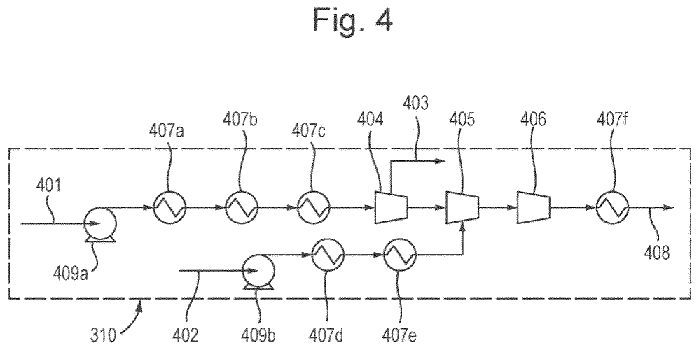

An example of a steam power cycle system 310 is shown in FIG. 4. The steam power cycle system 310 may comprise a first input conduit 401, a second input conduit 402, a first output conduit 403, a second output conduit 408, a high pressure turbine 404, an intermediate pressure turbine 405, a low pressure turbine 406, a first pump 409a, a second pump 409b, and a plurality of heat exchangers 407a, 407b, 407c, 407d, 407e, 407f.

The first input conduit 401 may be a supply of the water into the steam power cycle system 310. The water flows through the first pump 409a and heat exchangers 407a, 407b, 407c so that it is heated and high pressure steam is generated. Some of this high pressure steam may be supplied, via the first output conduit 403, to the second feedstock inlet 201b so that it may be used in the gasification process. Some of the steam that has flowed through the high pressure turbine may flow to the intermediate pressure turbine 405.

The second input conduit 402 is a further water supply into the steam power cycle system 310. The further water supply flows through heat exchangers and thereby increases the heat recovery of the overall system. This water may flow through the first pump 409a and then be heated in the heat exchangers 407d and 407e. The steam that flows through the intermediate pressure turbine 405 may flow to the low pressure turbine 406 and the heat exchanger 407f. The flow out of the second output conduit 408 may be low pressure steam. Depending on the process being performed in the reactor system 200, the low pressure steam that flows through the second output conduit 408 may alternatively, or additionally, be supplied to the second feedstock inlet 201b.

Each turbine in the steam power cycle system 310 may generate electricity and thereby recover energy.

Each of the plurality of heat exchangers 407a, 407b, 407c, 407d, 407e, 407f may be located in any of the fluid flow paths within, into, and/or out of the biomass gasification and hydrogen production system. For example, one of the heat exchangers 407a, 407b, 407c, 407d, 407e, 407f may be provided between the reactor system 200 and the gas-solid separator 304, another one of the heat exchangers 407a, 407b, 407c, 407d, 407e, 407f may be provided between the gas-solid separator 304 and the de-sulphurization reactor 305, another one of the heat exchangers 407a, 407b, 407c, 407d, 407e, 407f may be provided between the de-sulphurization reactor 305 and the cracking reactor 306, another one of the heat exchangers 407a, 407b, 407c, 407d, 407e, 407f may be provided between the cracking reactor 306 and the water gas shift reactor 307, another one of the heat exchangers 407a, 407b, 407c, 407d, 407e, 407f may be provided between the water gas shift reactor 307 and the a gas separation reactor 308, and another one of the heat exchangers 407a, 407b, 407c, 407d, 407e, 407f may be provided between the gas separation reactor 308 and the reactor system.

Each heat exchanger 407a, 407b, 407c, 407d, 407e, 407f may heat, or cool, any of the gas flows in a conduit of the biomass gasification and hydrogen production system to thereby heat, or cool, water or steam. The heat exchangers 407a, 407b, 407c, 407d, 407e, 407f thereby allow efficient heat recovery within the biomass gasification and hydrogen production system. The heat exchangers 407a, 407b, 407c, 407d, 407e, 407f may also be used to change the temperatures and pressures the fluid flows within the biomass gasification and hydrogen production system so that the fluids are more appropriately conditioned for the next process performed on them.

Accordingly, heat integration is provided by the use of heating reactors 202a, 202b in the reaction chamber 206 for supporting the endothermic reaction between biomass and steam, the use of heat exchangers for raising steam at an appropriate temperature and pressure, the use of heat exchangers for adjusting the temperatures of the fluid streams and also the use of turbines for generating power.

The reactor system 100, 200 with an internal heating system according to embodiments may alternatively be integrated into other process as described below.

The reaction chamber 101, 206 with an internal heating system according to embodiments may be integrated into a methane reforming process. Methane reforming is a highly endothermic process for the production of syngas from methane. Embodiments include performing a methane reforming process in the reaction chamber 101, 206 according to embodiments. The reaction chamber 101, 206 may be integrated into a hydrogen production system based on a steam methane reforming process.

Steam and methane may both be fed to the reaction chamber 101, 206. The reforming reaction performed in the reaction chamber 101, 206 converts these to syngas. The syngas may be output from the reaction chamber 101, 206 and further processes performed on it. These may include a water-gas-shift process and a separation process, such as a PSA process. An output of the separation process may be a substantially pure stream of hydrogen. The off-gas of the separation process may be a low grade gaseous fuel that can be supplied back to the heating reactors 104a, 104b, 104c, 202a, 202b for use as a fuel therein.

The reaction chamber 101, 206 with an internal heating system according to embodiments may alternatively, or additionally, be integrated into an ammonia production process as described below.

Ammonia may be produced from nitrogen and hydrogen. Hydrogen may be produced following a biomass gasification or methane reforming process, as described above. The substantial part of the oxygen depleted air that is output from the heating reactors 104a, 104b, 104c, 202a, 202b is nitrogen. This nitrogen source, together with the produced hydrogen, may be used as the feedstocks for an ammonia production process.

The reaction chamber 101, 206 with an internal heating system according to embodiments may alternatively be integrated into a methanol production process, or other gas-to-liquid production process, as described below.

For methanol production, a biomass gasification or methane reforming process may be used to produce syngas in the reaction chamber 101, 206, as described above. Syngas may alternatively be generated in dependence on methane, steam and/or carbon dioxide (as output from heating reactors 104a, 104b, 104c, 202a, 202b) providing the feedstocks to a reforming process in the reaction chamber 101, 206.

The syngas may be output from the reaction chamber 101, 206 and supplied to a methanol production process. The unconverted syngas in the methanol production train may be partly, or totally, used as a fuel by the heating reactors 104a, 104b, 104c, 202a, 202b. Heat recovery within the system may be used to generate steam for use in the reaction chamber 101, 206, and also generate power when steam turbines are used.

The reaction chamber 101, 206 with an internal heating system according to embodiments may alternatively, or additionally, be integrated into a pyrolysis process of biomass or waste as described below.

The reaction chamber 101, 206 may support the endothermic pyrolysis process. The reaction products of the pyrolysis process may comprise solids, liquids and a gaseous fuel. The solid and liquid reaction products may be separated out of the reaction chamber 101, 206. The gaseous fuel may be used as a fuel by the heating reactors 104a, 104b, 104c, 202a, 202b.

In all of the above-described embodiments, the further processing of the reaction outputs of the reaction chamber 101, 206, as well as the operation and supplying of fuel to the heating reactors 104a, 104b, 104c, 202a, 202b, may be similar to the above-described biomass gasification processes with reference to FIGS. 3 and 4. Heat exchangers may be used throughout the system to recover heat and turbines may be used to generate electrical power. All of the embodiments therefore provide an efficient production system with carbon dioxide capture.

Embodiments include a number of modifications and variations to the above-described processes.

Embodiments also include an alternative implementation of the reactor system 200 for certain applications that may include the reforming, cracking, or gasification of gaseous (e.g., natural gas or ammonia) or liquid fuels (e.g., coal/biomass slurries or oil). The reactor system may alternatively be configured so that the heat consuming process may be performed in what are shown in FIG. 2 as the tubes of the heating reactors 202a and 202b, and the heat producing process may be performed outside of these tubes. The heat generation and consumption regions with the reaction chamber 206 are therefore the inverse to what was described in the above embodiments. The present embodiment may allow for larger pressure differences between the tubes and the rest of the reaction chamber 206, and faster fluidization of the heat producing process that may improve process efficiency and reduce capital costs.

FIG. 1 shows a heating system that comprises three heating reactors 104a, 104b and 104c, and FIG. 2 shows a heating system that comprises two heating reactors 202a and 202b. However, the heating systems according to embodiments may comprise any number of heating reactors. For example, the number of heating reactors may be in the range 2 to 20.

Each heating reactor may comprise one or more tubes that pass through the reaction region of the reaction chamber 101, 206. The number of tubes may be 1 to 20.

The plurality of heating reactors, and/or each tube of a heating reactor, may be substantially equally distributed within the reaction chamber 101, 206.

In the above described embodiments, both the oxidation and reduction processes of the oxygen carrier materials are exothermic. Embodiments also include the use of oxygen carrier materials for which the oxidation process is highly exothermic and the reduction process is endothermic. So long as the energy released in the oxidation process is substantially more than the energy required by the reduction process, effective heating will still occur.

In embodiments, the fuel used within each heating reactor is gaseous. Embodiments include obtaining a liquid fuel for use in a heating reactor. The liquid fuel may be heated so that it becomes a gaseous fuel. The gaseous fuel may then be fed into the heating reactor.

The biomass gasification process, as described with reference to FIGS. 2 and 3, may alternatively use the heating system as described with reference to FIG. 1.

In embodiments, the heating system is supplied with air for the oxidation process of the oxygen carrier material. Embodiments alternatively include supplying the heating system with substantially pure oxygen instead of air. The substantially pure oxygen may be generated onsite by an air separation unit.

Embodiments also include the heating system operating without gas switching between a plurality of heating reactors. This may be implemented by supplying substantially pure oxygen to each heating reactor instead of air. The heating system may be similar to that shown in FIG. 2 but adapted so that the reaction chamber 206 effectively comprises a single reactor that has separate reactor tubes 202a, 202b. Instead of the plurality of air supplies 203b, 203d and fuel supplies 203a, 203e, the reactor in the reaction chamber 206 may receive a continuous supply of fuel through the inlet 203c and a continuous supply of substantially pure oxygen through the inlet 203f. Within the reactor, a fluidised oxygen carrier material may indirectly combust the fuel with the oxygen to ensure complete conversion and avoid hot spots. The reactor may simultaneously support a reduction reaction between some of the oxygen carrier material and the fuel, as well as an oxidation reaction between some of the oxygen carrier material and oxygen in the internal region of the heating reactor. The combustion products, that may substantially consist of CO₂ and H₂O, may continuously flow out of the reactor in the reaction chamber 206 through the outlets 205a, 205d. In the present embodiment, the substantially pure oxygen that is supplied through the inlet 203f may be generated by an onsite air separation unit. The use of an air separation unit may be an additional cost. However, because no gas switching is required, the cost of operating the heating system may be reduced. The overall cost of operating the heating system may therefore be substantially unchanged, or reduced. The heating system may also be easier to operate.

Embodiments include the biomass gasification process, as described with reference to FIGS. 2 and 3, comprising a slurry pump system instead of the lock hopper system 301. A liquid slurry may comprise biomass and water. The slurry may be pressurised to the same pressure as that in the reaction chamber 206 of the reactor system 200. The liquid slurry may be supplied to the slurry pump system. The liquid slurry may be supplied directly to the reactor system 200. Alternatively, before being fed into the reactor system 200, the slurry may flow through a heat exchanger so that the water in the slurry may be evaporated using waste heat from other parts of the overall system.

The heating system according to embodiments may be used to provide the heat for other types of endothermic process without the need for integration such as calcination processes. In this case, no need for using gaseous products from the endothermic reaction system; instead fuel to the heating system is supplied externally. When applicable, heat integration may be used to improve the overall efficiency of the system. The system may capture carbon dioxide, or any other gaseous exhaust product from the heating system, as described above.

All of the components of the reactor system of embodiments are scalable such that implementations of embodiments are appropriate for small, medium and large industrial scale processes.

The flow charts and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1. A reaction process system comprising:
a reactor system configured to support an endothermic reaction between a feedstock and steam; and
one or more heat exchangers arranged to generate the steam by heating water with heat recovered in dependence on one or more fluid flows out of the reactor system: and
a steam supply conduit arranged to supply at least some of the generated steam to the reactor system:
wherein the reactor system comprises:
a reaction chamber with an internal region arranged to support the endothermic reaction between the feedstock and the steam:
a heating system that is at least partially within the internal region of the reaction chamber;
the heating system comprises a plurality of heating reactors:
each heating reactor comprises walls that separate an internal region of the heating reactor from the rest of the internal region of the reaction chamber;
each heating reactor comprises an oxygen carrier material in the internal region of the heating reactor:
each heating reactor is arranged to support a reduction reaction between the oxygen carrier material and a fuel in the internal region of the heating reactor; and
each heating reactor is arranged to support an oxidation reaction between the oxygen carrier material and oxygen in the internal region of the heating reactor.

2. The reaction process system according to claim 1, wherein the reactor system comprises:
a first set of one or more output conduits for providing a flow out of the reactor system of reaction products generated in the internal region of each heating reactor; and
a second set of one or more output conduits for providing a flow out of the reactor system of reaction products generated in the internal region of the reaction chamber and outside of the heating system.

3. The reaction process system according to claim 1, wherein the reactor system comprises:
a first set of one or more output conduits for providing a flow out of the reactor system of reaction products generated in the internal region of each heating reactor; and
a second set of one or more output conduits for providing a flow out of the reactor system of reaction products generated in the internal region of the reaction chamber and outside of the heating system; and
wherein the first set of one or more output conduits comprises an output conduit for a flow of depleted air generated by the oxidation reaction in the heating system: and an output conduit for a flow of gas generated by the reduction reaction in the heating system.

4. The reaction process system according to claim 1, wherein the reactor system comprises:
a first set of one or more output conduits for providing a flow out of the reactor system of reaction products generated in the internal region of each heating reactor; and
a second set of one or more output conduits for providing a flow out of the reactor system of reaction products generated in the internal region of the reaction chamber and outside of the heating system; and
wherein the first set of one or more output conduits comprises an output conduit for a flow of depleted air generated by the oxidation reaction in the heating system, and an output conduit for a flow of gas generated by the reduction reaction in the heating system; and
wherein the flow of gas generated by the reduction reaction comprises carbon dioxide.

5. The reaction process system according to claim 1, wherein the reactor system comprises:
a first set of one or more output conduits for providing a flow out of the reactor system of reaction products generated in the internal region of each heating reactor; and
a second set of one or more output conduits for providing a flow out of the reactor system of reaction products generated in the internal region of the reaction chamber and outside of the heating system; and
wherein the first set of one or more output conduits comprises an output conduit for a flow of depleted air generated by the oxidation reaction in the heating system, and an output conduit for a flow of gas generated by the reduction reaction in the heating system; and
wherein the flow of gas generated by the reduction reaction comprises carbon dioxide and steam: and
the reaction process system further comprises a condenser arranged to condense the steam in the flow of gas generated by the reduction reaction.

6. The reaction process system according to claim 1, wherein the reactor system comprises:
a first set of one or more output conduits for providing a flow out of the reactor system of reaction products generated in the internal region of each heating reactor; and
a second set of one or more output conduits for providing a flow out of the reactor system of reaction products generated in the internal region of the reaction chamber and outside of the heating system,
wherein the second set of one or more output conduits comprises the reaction products from the reaction between the feedstock and steam.

7. The reaction process system according to claim 1, wherein the reactor system comprises:
a first set of one or more output conduits for providing a flow out of the reactor system of reaction products generated in the internal region of each heating reactor; and
a second set of one or more output conduits for providing a flow out of the reactor system of reaction products generated in the internal region of the reaction chamber and outside of the heating system.
wherein the second set of one or more output conduits comprises the reaction products from the reaction between the feedstock and steam; and
wherein the reaction products from the reaction between the feedstock and steam comprise syngas.

8. The reaction process system according to claim 1, wherein the reactor system comprises:
a first set of one or more output conduits for providing a flow out of the reactor system of reaction products generated in the internal region of each heating reactor; and
a second set of one or more output conduits for providing a flow out of the reactor system of reaction products generated in the internal region of the reaction chamber and outside of the heating system;
wherein, in use, the fuel used in a reduction reaction in the heating system is at least in part dependent on the reaction products output from the second set of one or more output conduits of the reactor system.

9. The reaction process system according to claim 1, wherein the reactions in the internal region of each heating reactor are fluidised bed reactions.

10. The reaction process system according to claim 1, wherein the reaction process system further comprises one or more turbines arranged to generate electricity in dependence on one or more fluid flows within, and/or out of, the reaction process system.

11. The reaction process system according to claim 1, wherein the reaction process system further comprises one or more further processing systems on reaction products: and
the one or more further processing systems include one or more of a gas-solid separator, a desulphurization reactor, a cracking reactor, a water gas shift reactor, a gas separation reactor, a membrane based gas separator, a steam power cycle system, a captured gas separator, and a turbine system,
wherein each of the one or more heat exchangers is arranged in a fluid flow path between two of the further processing systems, a fluid flow path between the reactor system and a further processing system, a fluid flow path into the reaction process system, and/or a fluid flow path out of the reaction process system.

12. (canceled)

13. The reaction process system according to claim 1, wherein the feedstock comprises biomass and/or methane.

14. The reaction process system according to claim 1, the reaction process system further comprising a lock hopper system:
wherein:
the lock hopper system is arranged to receive biomass and a flow of pressurised carbon dioxide for pressurising the content of the lock hopper system: and
the lock hopper system is arranged to provide the feedstock to the reaction chamber of the reactor system.

15. The reaction process system according to claim 1, the reaction process system further comprising:
a slurry pump system arranged to receive a slurry and to provide the feedstock to the reaction chamber of the reactor system; and
a heat exchanger arranged in a flow path between the slurry pump system and the reactor system:
wherein:
the slurry comprises biomass and water; and
the heat exchanger is arranged to evaporate water in the slurry.

16. The reaction process system according to claim 1, wherein the reaction process system is arranged to support one or more of a biomass gasification process, a methane reforming process, an ammonia production process, a syngas production process, methanol production process, and a hydrogen production process.

17. The reaction process system according to claim 1, wherein the reactor system is arranged to support any endothermic process, such as calcination, without the need for using gaseous products from the endothermic process as a fuel: and
the reaction process system is arranged to receive fuel for use by the heating system from a fuel supply that is external from the reaction process system.

18. The reaction process system according to claim 1, further comprising:
one or more conduits configured to supply substantially pure oxygen to the heating system for supporting the oxidation reaction in each heating reactor; and
an air separation unit arranged to generate the supply of substantially pure oxygen.

19. (canceled)

20. A reaction process system comprising a reactor system that comprises:
a reaction chamber with an internal region arranged to support an endothermic reaction; and
a heating system that is at least partially within the internal region of the reaction chamber:
wherein:
the heating system comprises at least one heating reactor;
each heating reactor comprises walls that separate an internal region of the heating reactor from the rest of the internal region of the reaction chamber:
each heating reactor comprises an oxygen carrier material in the internal region of the heating reactor;
each heating reactor is arranged to simultaneously support both a reduction reaction between at least some of the oxygen carrier material and a fuel and also an oxidation reaction between at least some of the oxygen carrier material and oxygen in the internal region of the heating reactor; and
the heating system further comprises at least one conduit arranged to supply fuel and at least one conduit to supply substantially pure oxygen to each heating reactor.

21. The reaction process system according to claim 20, wherein the reactor system is configured to support an endothermic reaction between a feedstock and steam; and
the reaction process system further comprises one or more heat exchangers arranged to generate the steam by heating water with heat recovered in dependence on one or more fluid flows out of the reactor system; and
a steam supply conduit arranged to supply at least some of the generated steam to the reactor system.

22. The reaction process system according to claim 20, further comprising an air separation unit arranged to generate the supply of substantially pure oxygen to each heating reactor.
